(19) United States
(12) Patent Application Publication
(10) Pub. No.: US 2014/0320756 A1
(43) Pub. Date: Oct. 30, 2014

(54) TOUCH PANEL

(71) Applicant: TIANJIN FUNAYUANCHUANG TECHNOLOGY CO.,LTD., (US)

(72) Inventors: Po-Sheng SHIH, New Taipei (TW); Yu-Ju HSU, New Taipei (TW)

(73) Assignee: TIANJIN FUNAYUANCHUANG TECHNOLOGY CO.,LTD., Tianjin (CN)

(21) Appl. No.: 13/870,985

(22) Filed: Apr. 26, 2013

(51) Int. Cl. G02F 1/1333

(52) U.S. Cl. CPC G02F 1/13338; Y10S 977/953; B82Y 15/00
USPC 349/12; 977/953

(57) ABSTRACT

A touch panel includes a first electrode plate and a second electrode plate. The first electrode plate includes a first substrate and a first transparent conductive layer. The second electrode plate includes a second substrate and a second transparent conductive layer opposite to and spaced from the first transparent conductive layer. The first substrate defines a first curved surface, and first transparent conductive layer is located on the first curved surface. The second substrate defines a second curved surface, and the second transparent conductive layer is located on the second curved surface. The second transparent conductive layer is a conductive film having different resistance along different directions.

### BACKGROUND

1. Technical Field

The disclosure relates to touch panels, and particularly, to a carbon nanotube-based touch panel.

2. Description of Related Art

Various electronic apparatuses such as mobile phones, car navigation systems, and the like are equipped with optically transparent touch panels applied over display devices such as liquid crystal panels. The electronic apparatus is operated when contact is made with the touch panel corresponding to elements appearing on the display device. A demand thus exists for such touch panels to maximize visibility and reliability in operation.

A resistive touch panel often includes a layer of indium tin oxide (ITO) used as an optically transparent conductive layer. The ITO layer is generally formed by ion beam sputtering, a relatively complicated undertaking. Furthermore, the ITO layer is rigid, and cannot be curved. Whereby, the touch panel cannot be a flexible touch panel or have a curved surface.

What is needed, therefore, is a touch panel that can overcome the above-described shortcomings.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view an embodiment of a touch panel.

FIG. 2 is a transverse cross-sectional view along line II-II of the touch panel of FIG. 1.

FIG. 3 is a schematic view of a first electrode plate used in the touch panel of FIG. 1.

FIG. 4 is a schematic view of a second electrode plate used in the touch panel of FIG. 1.

FIG. 5 is a schematic view of a first electrode plate used in a touch panel of another embodiment.

FIG. 6 is a schematic view of a second electrode plate used in a touch panel of another embodiment.

FIG. 7 is a schematic view of a second electrode plate used in a touch panel of another embodiment.

FIG. 8 is a schematic planar view of a second transparent conductive layer used in the second electrode plate in FIG. 7.

FIG. 9 is a schematic planar view of a first electrode plate and a second electrode used in a touch panel of still another embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

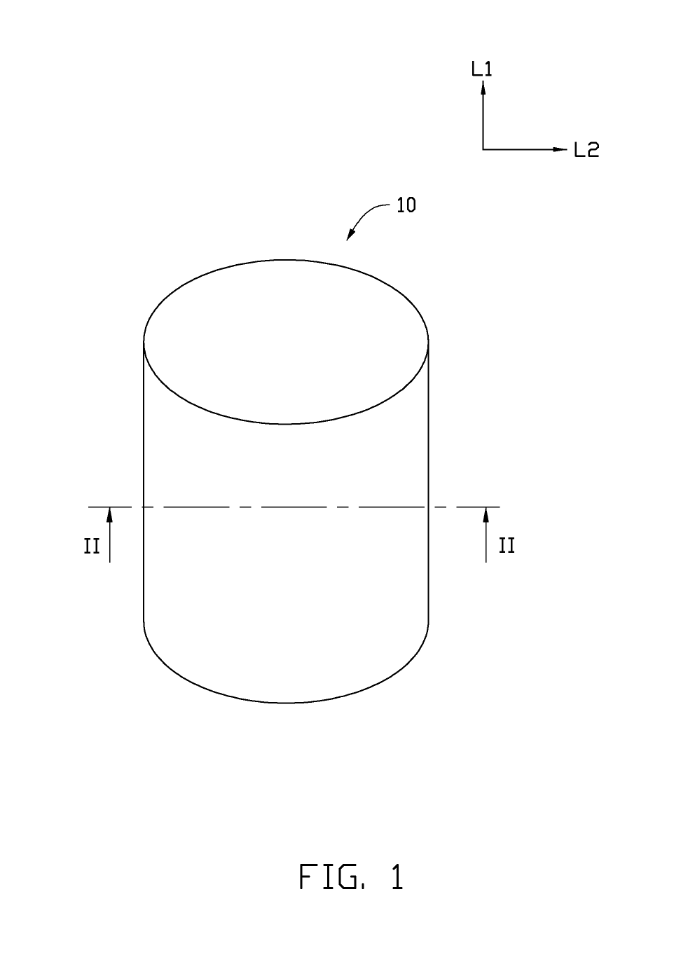

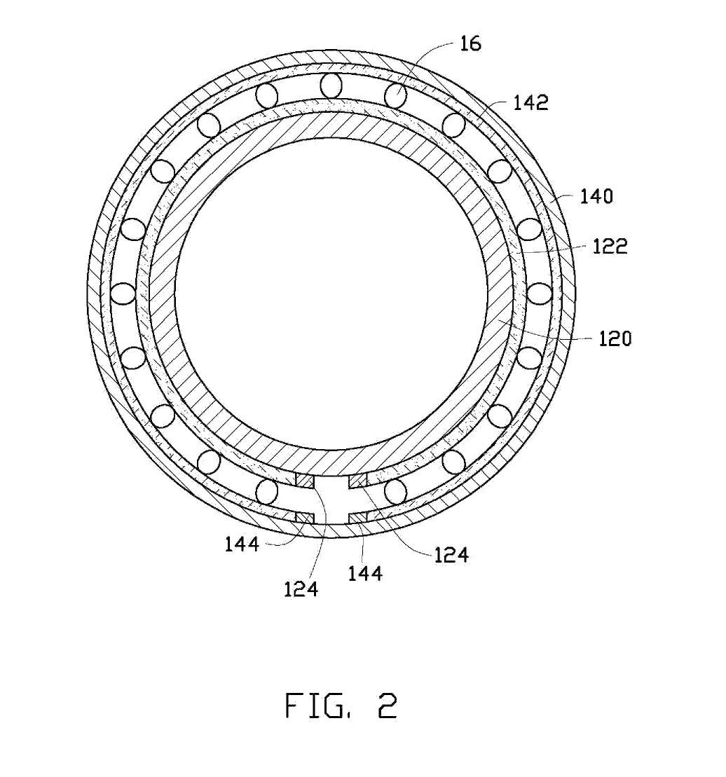

Referring to FIGS. 1-4, one embodiment of a touch panel 10 comprises a first electrode plate 12, a second electrode plate 14, a plurality of transparent dot spacers 16 located between the first electrode plate 12 and the second electrode plate 14.

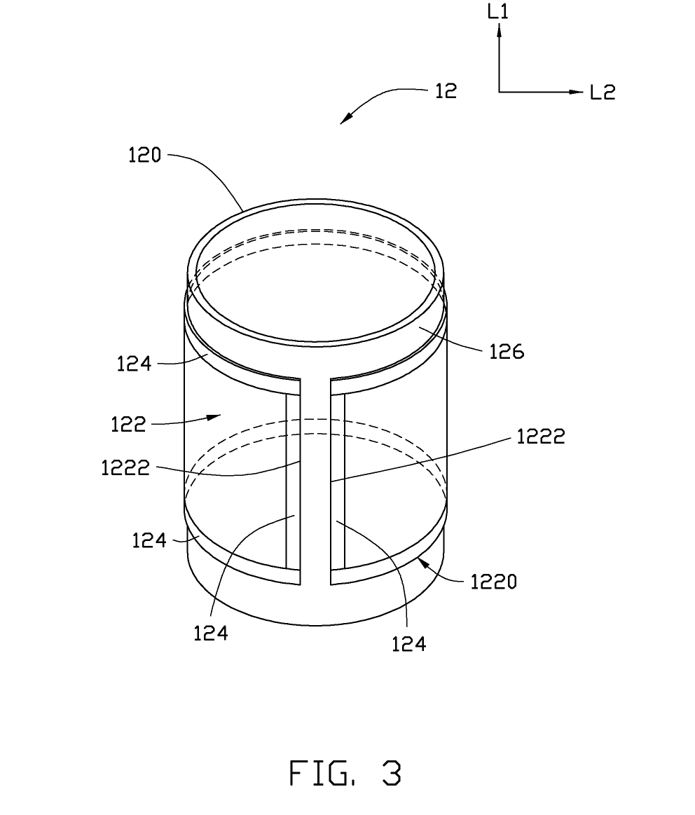

Referring also to FIG. 3, the first electrode plate 12 includes a first substrate 120, a first transparent conductive layer 122, and a first electrode 124. The first substrate 120 defines at least one curved surface. In the embodiment according to FIG. 3, the first substrate 120 includes a first curved surface 126 facing and spaced from the second electrode plate 14. The first transparent conductive layer 122 is located on the first curved surface 126 of the substrate 120. The first transparent conductive layer 122 defines two opposite first curved ends 1220a, 1220b and two opposite first straight ends 1222a, 1222b. The first electrode 124 is electrically connected with the first transparent layer 122. The first electrode 124 surrounds and contacts the first transparent conductive layer 122. In one embodiment illustrated in FIG. 3, the first electrode 124 is located on a surface of the first transparent conductive layer 122 and symmetrically aligned with the two first curved ends 1220a, 1220b and the first curved ends 1222a, 1222b of the first transparent conductive layer 122.

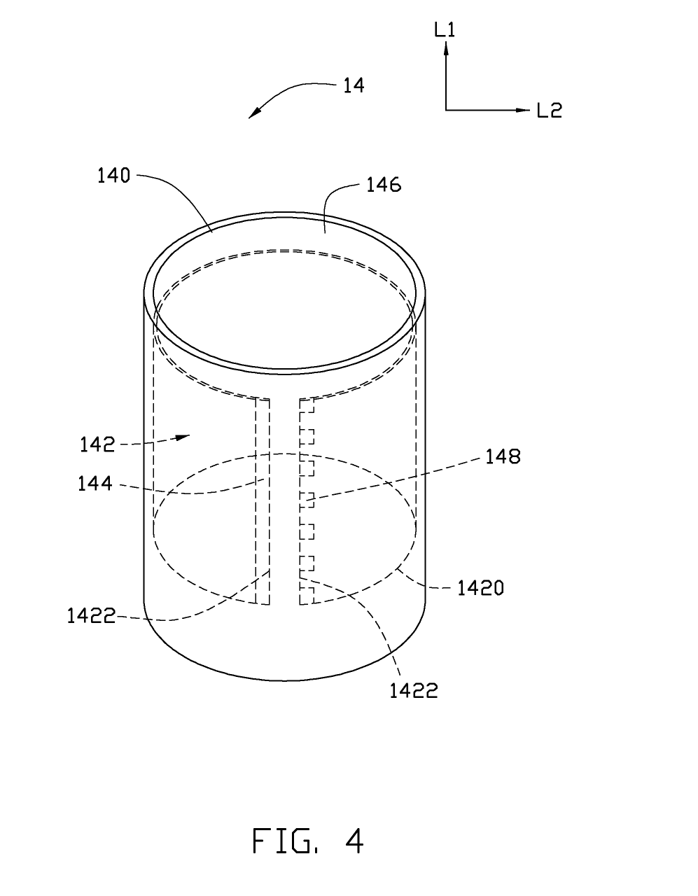

Referring to FIG. 4, the second electrode plate 14 includes a second substrate 140, a second transparent conductive layer 142, a second electrode 144, and a plurality of detecting electrodes 148. The second substrate 140 includes a second curved surface 146 facing and spaced from the first electrode plate 12. The second transparent conductive layer 142 is positioned on the second curved surface 146 and faces the first transparent conductive layer 122. The second curved surface 146 defines two opposite second curved ends 1420a, 1420b and two opposite second straight ends 1422a, 1422b. The second electrode 144 and the detecting electrodes 148 are electrically connected to the second transparent conductive layer 142. The second electrode 144 is located at the second straight ends 1422a of the second transparent conductive layer 142, the detecting electrodes 148 are located at the second straight ends 1422b of the second transparent conductive layer 142 opposite to the second electrode 144. The first curved surface 126 and the second curved surface 140 face each other. The first transparent conductive layer 122 and the second transparent conductive layer 142 face to each other. A shape of the first curved surface 126 is the same as that of the second curved surface 146. The shape of the first curved surface 126 and the second curved surface 146 can be spherical, elliptical, cylindrical or any other curved surface.

The first substrate 120 is configured to support the first transparent conductive layer 122 and the first electrode 124. The second substrate 140 is used to support the second transparent conductive layer 142 and the plurality of detecting electrodes 148. The first substrate 120 is a transparent board. The first substrate 120 and the second substrate 140 can be made of glass, diamond, quartz, plastic or any other suitable material. The first substrate 120 and the second substrate 140 can be made of a flexible material. The flexible material can be polycarbonate (PC), polymethyl methacrylate acrylic (PMMA), polyethylene terephthalate (PET), polyethersulfones (PES), polyvinylchloride (PVC), benzocyclobutenes (BCB), polyesters, or acrylic resins. The thickness of each of the first substrates 120 can range from about 1 millimeter to about 1 centimeter. The first curved surface 126 can be formed by bending the first substrate 120. In the embodiment according to FIGS. 1-4, the first substrate 120 has a cylinder structure. In one embodiment, the first substrate 120 and the second substrate 140 are made of PET, and each have a thickness of about 2 mm. The shape of the second substrate 140 is corresponding to the shape of the first substrate 120, and decided by the first substrate 120. In the embodiment according to FIGS. 1-4, the second substrate 140 has a cylinder structure, and an inner diameter of the second substrate 140 is a slightly greater than an outer diameter of the first substrate 120. The first substrate 120 and the second substrate 140 are coaxial.

The first transparent conductive layer 122 is attached on the first curved surface 126. Before applying the first transparent conductive layer 122 on the first curved surface 126, the first transparent conductive layer 122 has a planar structure. Then, the first transparent conductive layer 122 is curved and adhered on the first curved surface 126. In the embodiment, the first transparent conductive layer 122 is curved to have a C-shape and attached on the first curved surface 126. Each of the two opposite first curved ends 1220a, 1220b is a C-shaped line, and each of the two opposite first straight ends 1222a, 1222b is a straight line. The two first straight end 1222a and the first straight end 1222b are located adjacent each other. In other embodiment, an insulative element can be located between the two first straight ends 1222a, 1222b in case of a short circuit. The second transparent conductive layer 142 is attached on the second curved surface 146. Before applying the second transparent conductive layer 172 on the second curved surface 146, the second transparent conductive layer 142 has a planar structure. Then, the second transparent conductive layer 142 is curved and adhered on the second curved surface 146. In one embodiment, the second transparent conductive layer 142 is curved to have a C-shape and attached on the second curved surface 146. Each of the two opposite second curved ends 1420a, 1420b is a C-shaped line, and each of the two opposite second straight ends 1422a, 1422b is a straight line. The two second straight ends 1422a, 1422b are adjacent with each other. In other embodiment, an insulative element can be located between the two second straight ends 1422a, 1422b in case of a short circuit.

The first electrode 124, the second electrode 144 and the plurality of detecting electrodes 148 are made of conductive material, such as metal or alloy. The shapes of the first electrode 124 and the second electrode 144 can be linear, such as wire-shaped or bar-shaped. The shape of each detecting electrode 148 can be block-shaped. The cross sectional shape of the first electrode 124 and the second electrode 144 can be round, square, trapezium, triangular, or polygonal. The thickness of the first electrode 124, the second electrode 144 and the detecting electrode 148 can be any size, depending on the design, and can be about 1 micrometer to about 5 millimeters. In one embodiment, the first electrode 124 and the second electrode 144 are both silver wires made by a screen print method, and the detecting electrodes 148 are silver spots made by a screen print method.

Referring to FIG. 3, the first electrode 124 surrounds and contacts the first transparent conductive layer 122. In one embodiment illustrated in FIG. 3, the first electrode 124 is located on a surface of the first transparent conductive layer 122 and symmetrically aligned with the two first curved ends 1220a, 1220b and the two first straight ends 1222a, 1222b of the first transparent conductive layer 122. The parts of first electrode 124 adjacent with the first curved ends 1220a, 1220b are curved to have a C-shape. The other parts of the first electrode 124 adjacent with the first straight ends 1222a, 1222b are straight.

Referring to FIG. 4, the second electrode 144 is located at one end of the second transparent conductive layer 142, and the detecting electrodes 148 are located at another end of the second transparent conductive layer 142. In the embodiment according to FIG. 4, the second electrode 144 is adjacent the second straight end 1422a of the second transparent conductive layer 142, the plurality of the detecting electrodes 148 is adjacent with the second straight end 1422b of the second transparent conductive layer 142. The second electrode 144 is shown oriented along a first direction L1 and the detecting electrodes 148 are arranged along the first direction L1 as shown in FIG. 4. The first direction L1 is parallel with an axial direction of the first substrate 120 or the second substrate 140. The distance between adjacent detecting electrodes 148 can be uniform. A second direction L2 is perpendicular to the first direction L1 is shown in FIG. 4.

The first transparent conductive layer 122 includes a first carbon nanotube layer. The first carbon nanotube layer structure includes a plurality of carbon nanotubes joined by van der Waals attractive force therebetween. The first carbon nanotube layer structure can be a substantially pure structure of carbon nanotubes with few impurities. The first carbon nanotube layer structure can be a freestanding structure, that is, the first carbon nanotube layer structure can be supported by itself without a substrate. If at least one point of the carbon nanotube layer structure is held, the entire carbon nanotube layer structure can be lifted without being damaged. The carbon nanotubes in the first carbon nanotube layer structure can be disorderly arranged. The term ‘disordered carbon nanotube layer structure’ refers to a structure where the carbon nanotubes are arranged along different directions, and the aligning directions of the carbon nanotubes are random. The number of the carbon nanotubes arranged along each different direction can be almost the same (e.g. uniformly disordered). The disordered carbon nanotube layer structure can be isotropic, namely the carbon nanotube layer structure has identical properties in all directions of the carbon nanotube layer structure. The carbon nanotubes in the disordered carbon nanotube layer structure can be entangled with each other. The carbon nanotubes in the first carbon nanotube layer structure can be single-walled, double-walled, or multi-walled carbon nanotubes.

The second transparent conductive layer 142 can be a conductive film having different resistance along different directions, e.g., the resistivity of the second transparent conductive layer 142 in two-dimensional space is different. Referring to FIG. 4, the resistivity of the second transparent conductive layer 142 along the first direction L1 is greater than the resistivity of the second transparent conductive layer 142 along the second direction L2.

The second transparent conductive layer 142 can be a carbon nanotube layer structure including a plurality of carbon nanotubes. The carbon nanotube layer structure can be a freestanding structure. The plurality of carbon nanotubes in the carbon nanotube layer structure is substantially oriented along the second direction L2. That is, the carbon nanotubes are oriented from the second electrode 144 to the detecting electrodes 148. As such, a conductive passage is formed between each detecting electrode 148 and the second electrode 144. In one embodiment, the carbon nanotube layer structure is a pure structure of carbon nanotubes. The carbon nanotube layer structure can include at least one carbon nanotube film. In one embodiment, the carbon nanotube layer structure can include at least two stacked carbon nanotube films or a plurality of carbon nanotube films contiguously positioned side by side, with the carbon nanotubes in the carbon nanotube films substantially oriented along the second direction L2.

The carbon nanotube film includes a number of successive and oriented carbon nanotubes joined end-to-end by van der Waals attractive force therebetween. The carbon nanotube film is a free-standing film. Each carbon nanotube film includes a number of successively oriented carbon nanotube segments joined end-to-end by Van der Waals attractive force therebetween. Each carbon nanotube segment includes a number of carbon nanotubes substantially parallel to each other, and joined by Van der Waals attractive force therebetween. Some variations can occur in the carbon nanotube film. The carbon nanotubes in the carbon nanotube film are oriented along the second orientation L2. The carbon nanotube film can be treated with an organic solvent to increase the mechanical strength and toughness of the carbon nanotube film and reduce the coefficient of friction of the carbon nanotube film. The thickness of the carbon nanotube film can range from about 0.5 nanometer to about 100 micrometer.

An insulative layer can be further provided between the first electrode plate 12 and second electrode plate 14. In one embodiment, the insulative layer is in the form of a rectangular bead. The first electrode plate 12 is located on the insulative layer. That is, the first transparent conductive layer 122 faces, but is spaced from, the second transparent conductive layer 142. The dot spacers 16 are located on the second transparent conductive layer 142. A distance between the second electrode plate 14 and the first electrode plate 12 is typically in an approximate range from 2 microns to 10 microns. The insulative layer and the dot spacers 16 are made of, for example, insulative resin or any other suitable insulative material. Electrical insulation between the first electrode plate 12 and the second electrode plate 14 is provided by the insulative layer and the dot spacers 16. It is to be understood that the dot spacers 16 are optional, particularly if the size of the touch panel 10 is relatively small.

In one embodiment, a transparent protective film (not shown) is located on the upper surface of the first electrode plate 12. The material of the transparent protective film can be silicon nitrides, silicon dioxides, benzocyclobutenes, polyester films, or polyethylene terephthalates. For example, the transparent protective film can be made of slick plastic and receive a surface hardening treatment to protect the first electrode plate 12 from being scratched when in use.

In use of the touch panel 10, the touch panel 10 is attached on a display device. When a user touches the touch panel 10 at the touch point to cause the first transparent conductive layer 122 to contact the second transparent conductive layer 142, the touch panel 10 can detect the location of the touching point. The first electrode 124 and the second electrode 144 are the input electrodes inputting voltage signals, and the detecting electrodes 148 are the output electrodes outputting voltage signals. The location of the touch point can be detected by measuring a voltage of each detecting electrode 148. If there is a plurality of touching points, the detecting electrodes 148 can be used to detect the location of each touching point. The location of one touching point at the first direction L1 can be detected by the corresponding detecting electrode 148. The location of the touching point at the second direction L2 can be detected by the voltage change of the detecting electrode 148, because a change of the voltage of the detecting electrodes 148 is related to a vertical distance between the touching point and the second electrode 144. As such, the location of the touching point can be detected. Because the conductive passages between each detecting electrode 148 and the second electrode 144 do not affect each other, the locations of a plurality of touching points can be detected at the same time.

The touch panel 10 disclosed in the present disclosure has a plurality of advantages. First, the touch panel 10 has a curved structure, the user can operate the touch panel from different directions, and the touch panel 10 can be applied on a curved display device. Second, the touch panel 10 has a simple structure and can detect multiple touching points at the same time. Third, because the second transparent conductive layer 142 of the touch panel 10 includes a carbon nanotube layer structure including a plurality of carbon nanotubes oriented along a same direction, the carbon nanotube layer structure has different resistances along different directions, and the touch panel 10 can detect multiple touching points at the same time. Fourth, the first or second carbon nanotube layer structure is used as the transparent conductive layer in the touch panel 10. The first or second carbon nanotube layer structure is flexible and can be bent to any shape without being destroyed or changed the resistivity, as such, a shape of the touch panel 10 is not limited. The first or second carbon nanotube layer structure can sustain repeated a friction force from outside environment without being destroyed, such as, when a surface of the carbon nanotube layer structure is scrubbed by a rubber eraser, the carbon nanotube layer structure will not be destroyed by the friction force between it and the rubber eraser. As such, a process of making the touch panel 10 is easily operated.

Table 1 below is a comparison of resistivity between the carbon nanotube layer structure (CNT structure) and ITO under different radius of curvature. That is, carbon nanotube layer structure (labeled 1^{#} and 2^{#}) and the ITO (labeled 1^{#} and 2^{#}) are bent to have different radius of curvature, and the resistivity of them under different radius of curvature is compared. It is can be seen from table 1 that, the carbon nanotube nanotube structure can be bent to any shape with stable resistivity. However, when the radius of curvatures of ITO is less than 4.5 millimeter, the resistivity of ITO varies greatly. When the ITO is folded to have 0 radius of curvatures, it is broken circuit. However, when the carbon nanotube layer structure is folded to have 0 radius of curvatures, the resistivity is almost unchanged. As such, the carbon nanotube layer structure can be used as a transparent conductive layer is a touch panel having any shape.

TABLE 1

| | resistance (KΩ) | | | |
|---|---|---|---|---|
| radius of | CNT | CNT | | |
| curvature | structure | structure | ITO | ITO |
| (mm) | (1^{#}) | (2^{#}) | (1^{#}) | (2^{#}) |
| No bending | 13.6 | 14.8 | 2.0 | 1.9 |
| 45 | 13.6 | 14.8 | 2.0 | 1.9 |
| 35 | 13.6 | 14.8 | 2.0 | 1.9 |
| 13.5 | 13.6 | 14.8 | 2.0 | 1.9 |
| 6.5 | 13.7 | 14.9 | 2.1 | 2.0 |
| 4.5 | 13.8 | 15.0 | 2.7 | 2.7 |
| 0 | 29.5 | 24.9 | broken circuit | broken circuit |

Table 2, it is a comparison of anti-scrub characteristic between the carbon nanotube layer structure and ITO. The carbon nanotube layer structure is scrubbed by a rubber eraser under a force when the carbon nanotube layer structure is electrically connected with a circuit. The ITO is scrubbed by the same rubber eraser under the same force when the ITO is electrically connected with another circuit. It is can be seen from table 2 that the carbon nanotube layer structure will not result in broken circuit before being scrubbed for more than 240 times. However, the ITO will result in broken circuit under scrubbing once. As such, the carbon nanotube layer structure can sustain repeated scrub from outside without being destroyed, and, a process of making the touch panel 10 is easily operated.

TABLE 2

| | CNT structure | CNT structure | ITO | ITO |
|---|---|---|---|---|
| sample | (1^{#}) | (2^{#}) | (1^{#}) | (2^{#}) |
| scrubbing times | 248 | 245 | 1 | 1 |

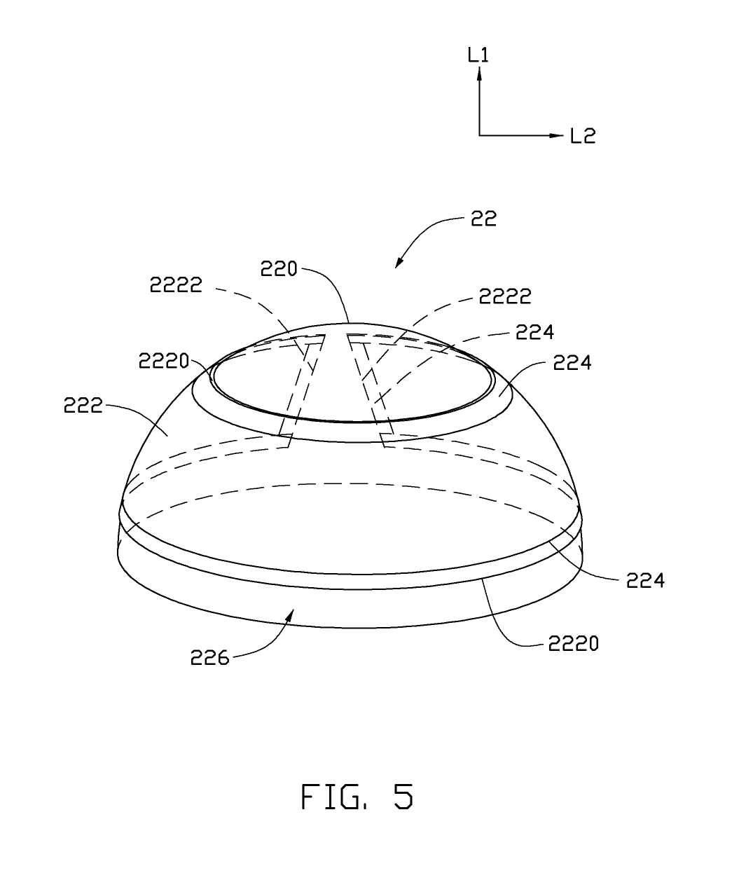

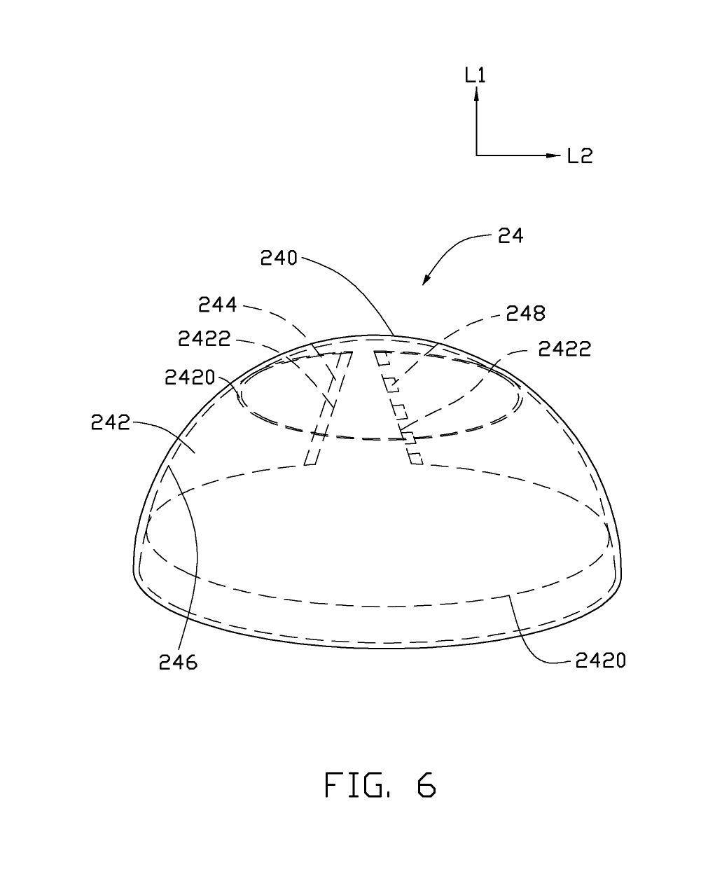

A touch panel 20 according to another embodiment includes a first electrode plate 22 and a second electrode plate 24 having the structures as shown in FIGS. 5 and 6. The first electrode plate 22 includes a first substrate 220, a first transparent conductive layer 222, and a first electrode 224. The first substrate 220 includes a first curved surface 226 facing and spaced from the second electrode plate 24. A first transparent conductive layer 222 and a first electrode 224 are located on the first curved surface 226 of the first substrate 220. The second substrate 240 includes a second curved surface 246. A second transparent conductive layer 242, a second electrode 244 and a plurality of detective electrodes 248 are located on the second curved surface 246 of the second substrate 240.

The first substrate 220 and the second substrate 240 both have a semisphere shape. And, the first curved surface 226 and the second curved surface 246 are both spherical surface. The first transparent conductive layer 222 has a rectangle structure and defines two opposite first curved ends 2220a, 2220b and two opposite first straight ends 2222a, 2222b. The first electrode 224 is located on a surface of the first transparent conductive layer 222 and symmetrically aligned with the two first curved ends 2220a, 2220b and the first curved ends 2222a, 2222b of the first transparent conductive layer 222. The second transparent conductive layer 242 has a rectangle structure and defines two opposite second curved ends 2420a, 2420b and two opposite second straight ends 2422a, 2422b. The second electrode 244 is located at the second straight ends 2422a of the second transparent conductive layer 242, the detecting electrodes 248 are located at the second straight ends 2422b of the second transparent conductive layer 242 opposite to the second electrode 244. The first transparent conductive layer 222 and the second transparent conductive layer 242 can overlap with each other after level shift.

Other characteristics of the touch panel 20 are the same as the touch panel 10 disclosed above.

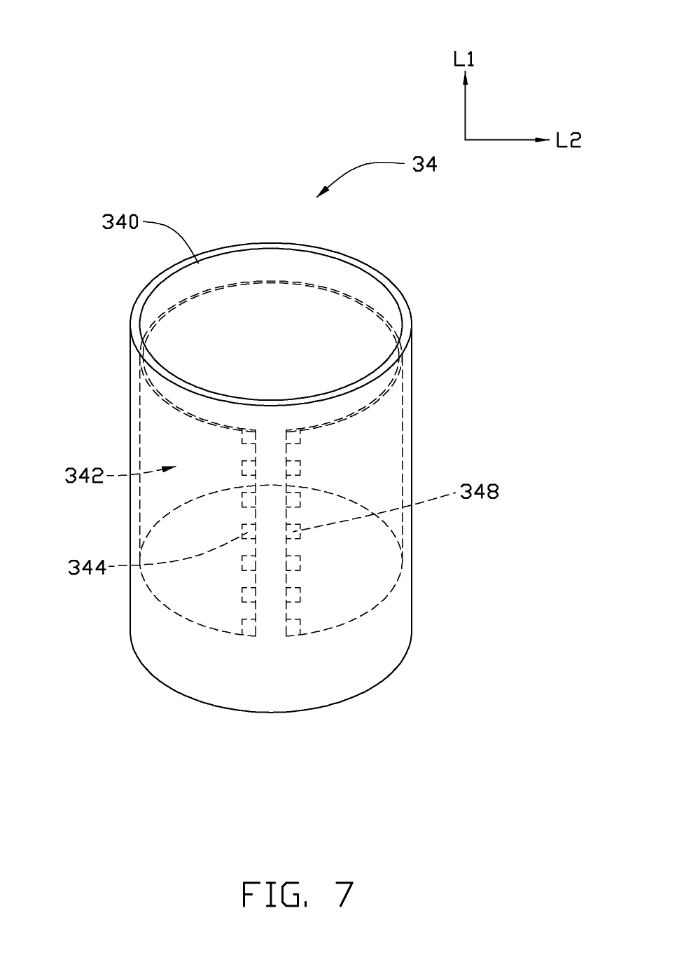

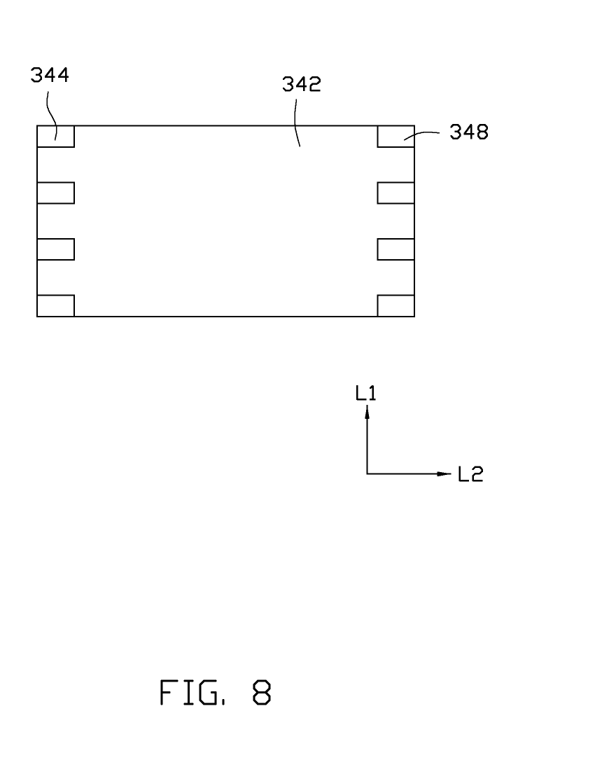

Referring to FIGS. 7 and 8, a touch panel according to another embodiment includes a first electrode plate (not shown) and a second electrode plate 34. The first electrode plate has the same structure as the structure of the first electrode plate disclosed above. The second electrode plate 34 includes a second transparent conductive layer 342, a plurality of first detecting electrodes 344, and a plurality of second detecting electrodes 348. The first detecting electrodes 344 and the second detecting electrodes 348 are electrically connected to the second transparent conductive layer 342. The first detecting electrodes 344 are located at one end of the second transparent conductive layer 342, and the second detecting electrodes348 are located at another end of the second transparent conductive layer 342 opposite the second detecting electrodes 348. The first detecting electrodes 344 are arranged along a first direction L1 as shown in FIG. 7. The second detecting electrodes 348 are also arranged along the first direction L1. The first detecting electrodes 344 and the second detecting electrodes 348 are respectively aligned opposite to each other. A distance between adjacent first detecting electrodes 344 can be uniform, and in a range from about 1 micrometer to about 100 micrometers. A distance between adjacent second detecting electrodes 348 can be uniform, and in a range from about 1 micrometer to about 100 micrometers. A second direction L2 is perpendicular to the first direction L1. A resistivity of the second transparent conductive layer 342 along the first direction L1 direction is larger than a resistivity along the second direction L2.

In one embodiment, the first detecting electrodes 344 can be used as input electrodes and the second detecting electrodes 348 can be used as output electrodes. In another embodiment, the first detecting electrodes 344 can be used as output electrodes and the second detecting electrodes 348 used as input electrodes. The method of using the touch panel is the same as the method of using the touch panel 10 disclosed above.

Other characteristics of the touch panel are the same as the touch panel 10 disclosed above.

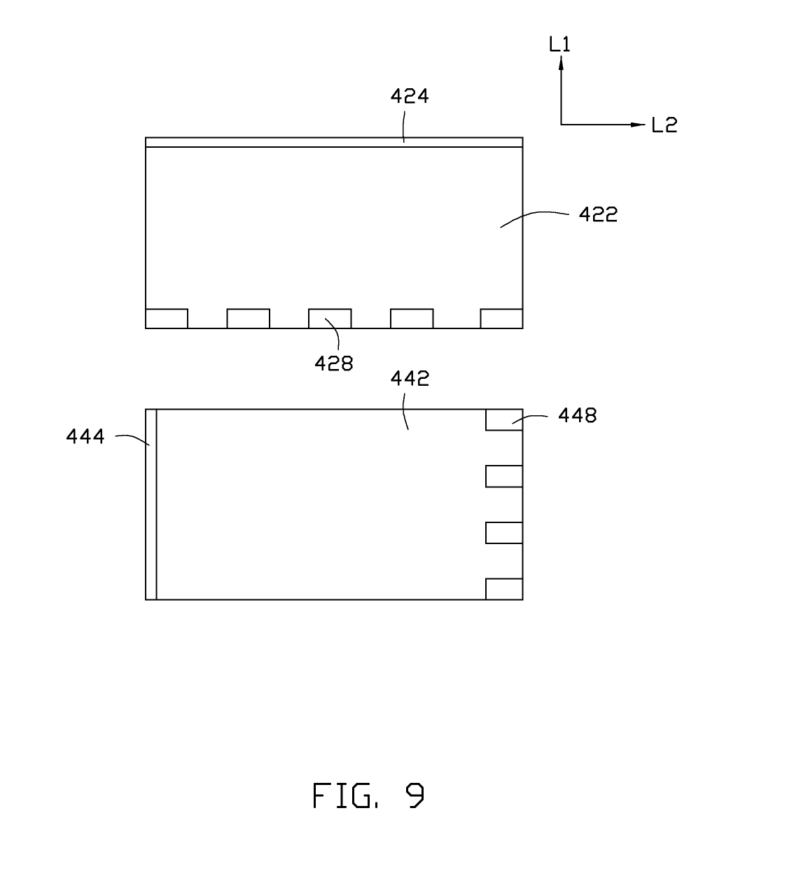

A touch panel according to another embodiment includes a first electrode plate and a second electrode plate. Referring to FIG. 9, the second electrode plate has the same structure as the structure of the second electrode plate disclosed above and includes a second transparent conductive layer 442, a second electrode 444, and a plurality of second detecting electrodes 448. The second electrode 444 is oriented along a first direction L1, as shown in FIG. 9. The second detecting electrodes 448 are arranged along the first direction L1. A second direction L2 perpendicular to the first direction L2 is shown in FIG. 9. A plurality of conductive passages is formed between the second electrode 444 and the second detecting electrodes 448.

The first electrode plate includes a first transparent conductive layer 422, a first electrode 424, and a plurality of first detecting electrodes 428. The first electrode 424 is oriented along the second direction L2. The first detecting electrodes 428 are arranged along the second direction L2. A distance between adjacent first detecting electrodes 428 can be uniform, and in a range from about 1 micrometer to about 100 micrometers. The first transparent conductive layer 422 can be a conductive film having different resistances along different directions, e.g., the resistivity of the first transparent conductive layer 422 in two-dimensional space is different. A resistivity of the first transparent conductive layer 422 along the second direction L2 is larger than the resistivity along the first direction L1. The first transparent conductive layer 422 can include the carbon nanotube layer structure having the same structure of the second carbon nanotube layer structure disclosed above. The carbon nanotubes in the carbon nanotube layer structure are oriented along the first direction L1. A conductive passage is formed between each first detecting electrode 428 and the first electrode 424, and a plurality of conductive passages is formed. The plurality of conductive passages formed between the first electrode 424 and the first detecting electrode 428 is substantially perpendicular to the conductive passages formed between the second electrode 444 and the second detecting electrodes 448.

In use of the touch panel, low voltage is input into the touch panel via the first electrode 424 and the first detecting electrodes 428, high voltage is input via the second electrode 444, and the location along the first direction L1 of a touching point can be detected by the second detecting electrodes 448. Low voltage is input into the touch panel via the second electrode 444 and the second detecting electrodes 448, high voltage is input via the first electrode 424, and the location along the second direction L2 of a touching point can be detected by the first detecting electrodes 428.

Other characteristics of the touch panel are the same as the touch panel 10 disclosed above.

It is to be understood that the described embodiments are intended to illustrate rather than limit the disclosure. Any elements described in accordance with any embodiments is understood that they can be used in addition or substituted in other embodiments. Embodiments can also be used together. Variations may be made to the embodiments without departing from the spirit of the disclosure. The disclosure illustrates but does not restrict the scope of the disclosure.

What is claimed is:

1. A touch panel comprising:
a first electrode plate comprising a first substrate and a first transparent conductive layer, the first substrate having a curved structure and defining a first curved surface, the first transparent conductive layer being located on the first curved surface;
a second electrode plate spaced apart from the first electrode plate and comprising a second substrate and a second transparent conductive layer, the second substrate having a curved structure and defining a second curved surface, the second transparent conductive layer being located on the second curved surface and facing the first transparent conductive layer; and
wherein the first transparent conductive layer comprises a first carbon nanotube layer structure, the second transparent conductive layer comprises a second carbon nanotube layer structure having different resistance along different directions, a resistivity of the second carbon nanotube layer structure along a first direction is larger than that along a second direction.

2. The touch panel of claim 1, wherein a shape of the first curved surface or the second curved surface is hemisphere, elliptical, cylinder or any other curved surface.

3. The touch panel of claim 1, wherein the first electrode plate further comprises a first electrode located at a surface of the first transparent conductive layer and superposed with four sides of the first transparent conductive layer.

4. The touch panel of claim 1, wherein the second electrode plate further comprises a second electrode located at one end of the second transparent conductive layer and a plurality of detecting electrodes located at another end of the second transparent conductive layer.

5. The touch panel of claim 4, wherein the second electrode is linear and oriented substantially along the first direction, each of the plurality of detecting electrodes is block shaped, and the plurality of detecting electrodes are arranged substantially along the first direction.

6. The touch panel of claim 1, wherein a resistivity of the first transparent conductive layer along the second direction is larger than a resistivity of the first transparent conductive layer along the first direction.

7. The touch panel of claim 6, wherein the first electrode plate further comprises a first electrode located at one end of the first transparent conductive layer and a plurality of first detecting electrodes located at another end of the first transparent conductive layer, the first electrode is linear and oriented substantially along the second direction, and the plurality of first detecting electrodes are block shaped and arranged substantially along the second direction.

8. The touch panel of claim 1, wherein the first carbon nanotube layer structure comprises a plurality of carbon nanotubes arranged randomly.

9. The touch panel of claim 1, wherein the second carbon nanotube layer structure comprises a plurality of carbon nanotubes substantially oriented along the second direction.

10. The touch panel of claim 9, wherein the second carbon nanotube layer structure is a pure structure of carbon nanotubes.

11. The touch panel of claim 9, wherein the plurality of carbon nanotubes in the second carbon nanotube layer structure are joined end-to-end with each other via Van der Waals attractive force.

12. The touch panel of claim 9, wherein the first carbon nanotube layer structure comprises a plurality of carbon nanotubes substantially oriented along the second direction, and the first direction is perpendicular with the second direction.

13. The touch panel of claim 1, wherein each of the first substrate and the second substrate has a cylinder structure, an inner diameter of the second substrate is a little greater than an outer diameter of the first substrate, and the first direction is parallel with an axial direction of the cylinder structure.

14. The touch panel of claim 13, wherein the first transparent conductive layer is curved to have a C-shape and wrapped around an outer surface of the first substrate, and the second transparent conductive layer is curved to have a C-shape and wrapped around an inner surface of the second substrate.

15. The touch panel of claim 1, wherein each of the first substrate and the second substrate has a semisphere structure.

16. A touch panel comprising:
a first electrode plate comprising a first substrate and a first transparent conductive layer, the first substrate defining a first curved surface, the first transparent conductive layer being located on the first curved surface, the first transparent conductive layer comprising a first carbon nanotube layer structure comprising a plurality of carbon nanotubes substantially oriented along a first direction;
a second electrode plate spaced apart from the first electrode plate and comprising a second substrate and a second transparent conductive layer, the second substrate defining a second curved surface, the second transparent conductive layer being located on the second curved surface and facing the first transparent conductive layer, the second transparent conductive layer comprising a plurality of carbon nanotubes substantially oriented along a second direction; and
wherein the first direction and the second direction are perpendicular with each other.

17. The touch panel of claim 16, wherein each of the first substrate and the second substrate have a cylinder structure, and an inner diameter of the second substrate is a little greater than an outer diameter of the first substrate, and the first direction is parallel with an axial direction of the cylinder structure.

18. The touch panel of claim 17, wherein the first transparent conductive layer is curved to have a C-shape and wrapped around an outer surface of the first substrate, the second transparent conductive layer is curved to have a C-shape and wrapped around an inner surface of the second substrate.

19. The touch panel of claim 1, wherein each of the first substrate and the second substrate has a semisphere structure.
